(19) United States
(12) Patent Application Publication
(10) Pub. No.: US 2026/0212623 A1
(43) Pub. Date: Jul. 23, 2026

(54) System and method for adaptive credential protection using steganography

(71) Applicant: Bank of America Corporation, Charlotte, NC (US)

(72) Inventors: A Subathra, Chennai (IN); Sunitha Sadanala Balaji, Chennai (IN); Vinodhini Paramasivan, Chennai (IN); Mohanapriya Subramani, Chennai (IN); Madhu Preetha Moorthy, Chennai (IN); Durga Prasad Khuttumolu, Hyderabad (IN); Ambika Shanmugam, Chennai (IN)

(21) Appl. No.: 19/034,269

(22) Filed: Jan. 22, 2025

(51) Int. Cl. G06T 19/20; G06F 21/62; G06T 7/20; G06T 13/40

(52) U.S. Cl. CPC G06T 19/20; G06F 21/629; G06T 7/20; G06T 13/40; G06T 2219/2004

(57) ABSTRACT

A system is configured to generate a virtual location and an avatar. The virtual location allows an external device to access an application using the avatar. Action data for actions performed by the avatar are recorded when the avatar enters the virtual location, and a deviation parameter indicating a probability that the external device is being controlled by a different user than an authorized user of the avatar is generated by comparing how much the actions performed by the avatar when the avatar enters the virtual location differ from actions that the avatar performed previously when entering the virtual location. When the deviation parameter is greater than a probability that indicates that the avatar may be compromised, the virtual location is altered using steganography to provide new credentials needed to access the application in the virtual location.

### TECHNICAL FIELD

The present disclosure relates generally to network communications and information security and, more specifically, to a system and method for adaptive credential protection using steganography.

### BACKGROUND

Virtual environments or metaverses allow users to interact with organizations and each other in new and exciting ways. Users may interact with each other, applications provided by the virtual environment's host, and other organizations through the use of avatars.

### SUMMARY

Conventional metaverse/virtual reality technology is currently unable to provide a consistently safe and secure virtual environment. This is especially problematic when organizations offer access to applications and/or data that, if misused, has real-world consequences. If a bad actor is able to gain control of a user's avatar or access the applications in other ways, they may be able to access information and/or applications that would not be accessible in the real world or better protected with such things as biological-based biometrics. For example, in the real world, access to an account may be protected with a user's fingerprint; however, in a virtual environment, such protections may not be possible. In the virtual environment, the bad actor may only need the user's login information and/or other credentials to access the same account.

With the proliferation of generative artificial intelligence (AI), bad actors are increasingly able to generate convincing deepfakes and bots that are able to take advantage of weaknesses in the security systems that protect applications and the metaverse in general. Even when attempts are made to provide better security, because AI has the ability to learn, new methods of attack may be quickly developed. This requires organizations that provide applications in the metaverse as well as those that provide the metaverse, to need to deploy even more sophisticated security methods.

These security methods, as they become more complex, require more computer resources, network resources, and ultimately human intervention to prevent the bad actors from taking advantage and/or damaging the underlying computer systems supporting the virtual environments and/or the reputation of the real-world organizations associated with the virtual environments. These security methods often put more burdens on users, such as remembering ever longer, more complex passwords in order to access applications, ultimately resulting in users no longer wishing to use the metaverse. When the user no longer wishes to use the metaverse to obtain the service, the services will need to be provided in the real world, resulting in the need for costly infrastructure, human resources, and other resources that the applications in the metaverse would have more efficiently provided.

The disclosed system is configured to identify when a bad actor may have compromised a user's avatar and uses steganography and other techniques to help legitimate users gain access to applications in the virtual environment while reducing the ability of bad actors to access those same applications. The system compares the actions that a user's avatar performs to those it performed when it initially accessed the virtual environment. If the amount of change, between the current actions and those initially performed is greater than a threshold, then the system implements steganographic techniques, such as, but not limited to, providing additional or new credentials in shadows, pictures, or in audio that a user through their avatar may then use to access a desired resource or application. The system also continues to monitor the avatar to determine if the avatar has been compromised and, for example, is a deepfake. The system, in one or more embodiments, creates additional avatars or decoys for the compromised avatar to interact with and learns from those interactions how to better identify compromised avatars.

The system and method disclosed in the present application include a processor operably coupled to a memory configured to store baseline action data for an avatar performing initial actions in a virtual location. The baseline action data provides information about each of a plurality of initial actions that the avatar performed when the avatar initially entered the virtual location for the first time. The virtual location is a virtual environment that allows an external device through the avatar to access an application that provides a resource associated with a second external device.

The processor initially receives a communication indicating that the avatar is entering the virtual location from an external device associated with the avatar. The processor generates the virtual location and the avatar and causes the external device to reproduce the virtual location and avatar on at least a graphical user interface (GUI) of the external device. The external device is allowed to control the avatar and to cause it to interact with the virtual location. The processor tracks the avatar and records action data for actions performed by the avatar when the avatar enters the virtual location.

While the avatar begins interacting with the virtual location, the processor generates a deviation parameter that indicates a probability that the external device is being controlled by a different user who is not an authorized user of the avatar. The processor generates the deviation parameter by comparing how much the actions performed by the avatar when the avatar enters the virtual location differ from the plurality of initial actions stored in the baseline action data. When the deviation parameter exceeds the first threshold probability, indicating that the avatar may be compromised, the processor alters the virtual location to include new credentials using steganography.

When altering the virtual location using steganography, the processor changes one or more normal elements of the virtual location using steganographic techniques to include new credentials for accessing the application. The one or more normal elements are elements that normally would not include credentials, such as shadows or reflections. The processor causes the external device to reproduce the changed one or more normal elements of the virtual location.

At a later time, the processor receives a second communication from the external device indicating that the avatar is requesting access to the application. The processor then requests credentials for accessing the application from the external device. In response, the processor receives the credentials for accessing the application from the external device and allows the external device, through the avatar, to access the application when the new credentials are included in the credentials received from the external device.

In one or more embodiments, if the processor determines that the deviation parameter is greater than a second threshold probability that indicates a bad actor is controlling the avatar, the processor flags the avatar and external device and takes additional actions. The processor removes the new credentials from the one or more normal elements and disables access for the avatar to the application. The processor continues tracking the avatar and records any additional action data as threat data. The processor may generate a plurality of decoys that may take the form of additional avatars configured to prevent a bad actor associated with the avatar form, determining that they have been detected by using generative AI to cause the decoys to communicate with the avatar as well as perform other actions. The processor then communicates the identification information of the avatar and the external device with additional external devices that provide additional virtual locations or applications. The processor uses the collected threat data to train AI models for detecting and/or generating the deviation parameter and also shares the collected threat data with threat prevention devices.

Utilizing steganography makes it more difficult for potential bad actors to access and use computer resources they are not authorized to use. The use of steganography allows for real-time prevention of unauthorized access while permitting authorizing access with little inconvenience or extensive computations required in comparison to other techniques, such as cryptographic techniques. Cryptographic techniques, while potentially securing a particular virtual location or environment, require large amounts of computations, both by the user equipment and by the computer(s) providing the virtual environment and/or application within it. Not having to perform as many or any cryptographic calculations leads to a better performance of such things as virtual reality (VR) headsets that a user experiences the virtual location with. Users do not enjoy when there is a delay between their actions and the resulting change in the environment displayed on the screens of their devices. However, since VR headsets and other user devices have limited computational ability, the need to perform increasingly complex cryptographic calculations to access the virtual location or resources hosted therein causes poor performance for the users. Alternatively, if more advanced cryptographic and security protocols are not implemented, users could even have their devices hijacked for nefarious purposes. Using steganographic techniques keeps resources secure while ultimately reducing the network and computing resources wasted on attacks.

Further, the steganographic techniques are combined with decoys, making the system even more effective and efficient. The decoys keep the bad actors and their avatars from detecting the steganographic credentials, offering a further layer of protection. The system utilizing the decoys may also learn information about the attackers or at least give other security systems time to investigate them and/or take actions against the attackers, including action in the real world, such as involving law enforcement. This may further reduce attacks on computer resources by reducing the need for computer and network resources to host compromised avatars and interact with bad actors' computer systems and devices. Further, the decoys may identify user devices and other external devices that have been compromised, allowing for notification of the authorized user or outside real-world entities that they need to take action to recover the devices.

By using steganographic techniques combined with decoys, authorized users may feel more confident in using the virtual environments to access their applications. This allows for many real-world activities to be performed more efficiently in the virtual environment, such as conducting transactions and other actions that they would normally do less efficiently in the real world. This reduces the amount of real-world personnel and resources, such as buildings that are needed for things such as banking and shopping, which may be more efficient and secure in a virtual environment.

The disclosed system, in real-time, efficiently prevents unauthorized access to an organization's applications and resources and counters the evolving nature of the threats. The disclosed system allows authorized users easy access to the organization's applications and resources without the user's device and/or the system needing to perform complex computations. The system is able to observe actions such as micro gestures that the avatar performs that a human observer would be unable to observe, and the system may automatically determine, based on those micro gestures and other characteristics of the avatar, if the avatar is being controlled by its authorized user or by a bad actor. Based on these conclusions, the system can automatically add extra layers of security such as the steganographic techniques, that prevent bad actors from being able to access applications, while still keeping the applications available to authorized users. The system can also perform actions to allow for collecting more information on the bad actor's devices and the bad actor itself to adjust such things as firewalls, security applications, and/or notify authorities so that legal actions can be taken to stop the bad actor.

Certain embodiments of the present disclosure may include some, all, or none of these advantages. These advantages and other features will be more clearly understood from the following drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1A illustrates one embodiment of a system configured to allow a user to interact with a virtual location in a virtual environment;

FIG. 1B illustrates one embodiment of a user device of FIG. 1A that allows a user to interact with a virtual location in a virtual environment;

FIG. 2 illustrates one embodiment of a flowchart for using adaptive credential protection using steganography.

### DETAILED DESCRIPTION

As described above, conventional solutions for providing security for an application provided in a virtual location are insufficient and may result in critical information and/or user information being compromised. The conventional solutions may be overcome with deepfakes and other methods that leverage artificial intelligence (AI) to learn and adapt to the security methods currently provided. When these security methods fail to secure critical information and resources, users are less likely to use applications that have real-world consequences within virtual environments. This reduces the usefulness of virtual environments and the incentives for further developing and providing them.

One or more embodiments of this disclosure provide a system and method that identifies avatars that bad actors have compromised by monitoring the actions the avatars perform and comparing them to previous actions. By detecting small variations such as, but not limited to, micro gestures, eye movements, and number of movements/commands needed to move the avatar from one location to another, a comprised avatar may be detected even when a sophisticated AI is controlling the avatar. In one or more embodiments, these variations may be detected using AI, which allows the detection ability to evolve even as the sophistication of the bad actors also evolves. This helps to keep virtual locations within a virtual environment safe and uncompromised.

Once the compromised avatars are detected, one or more embodiments of this disclosure utilize steganography and decoys to keep the compromised avatars from being able to access applications. These methods allow uncompromised avatars to still access those applications without the need for extensive calculations being performed by the user's devices using cryptographic techniques, the remembering of complicated passwords, and/or the exchange of biometric data of the user. This results in a better experience for authorized users with less undesirable lag and potential loss of sensitive user information. The decoys direct the compromised avatars away from observing or recognizing the new credentials being provided by utilizing steganography. The decoys may also allow the system and method of one or more embodiments of this disclosure the ability to collect data on the compromised avatars, update AI models based on new behaviors of comprised avatars, and collect threat data that is useful for other security systems to take preventive actions, including notifying appropriate authorities, notifying users to remove malware from their devices, and performing other actions to mitigate attacks on the virtual environment.

One or more embodiments of this disclosure provide a system and method that utilizes steganography and decoys to provide adaptive credential protection in a virtual environment. When an external device causes an avatar to enter a virtual location in the virtual environment, the avatar is tracked. The action data for the avatar is recorded and compared to baseline data for the avatar stored in the memory. A deviation parameter or score is determined and compared to a threshold; when the deviation parameter is above the threshold, new credentials for accessing an application are provided to the avatar using steganography, which hides the new parameters in things such as shadows, sounds, or other elements of the virtual location that would not usually contain credentials. The user may access the application using the new credentials, while a compromised avatar would most likely not detect the new credentials and be unable to access the application. The compromised avatar is monitored, and decoys may be deployed to distract the compromised avatar, allowing threat data on the external device and/or deepfake controlling the avatar to be collected, allowing the system and method to learn and for appropriate actions to be taken to mitigate the threat of the compromised avatar, external device, and/or deepfake.

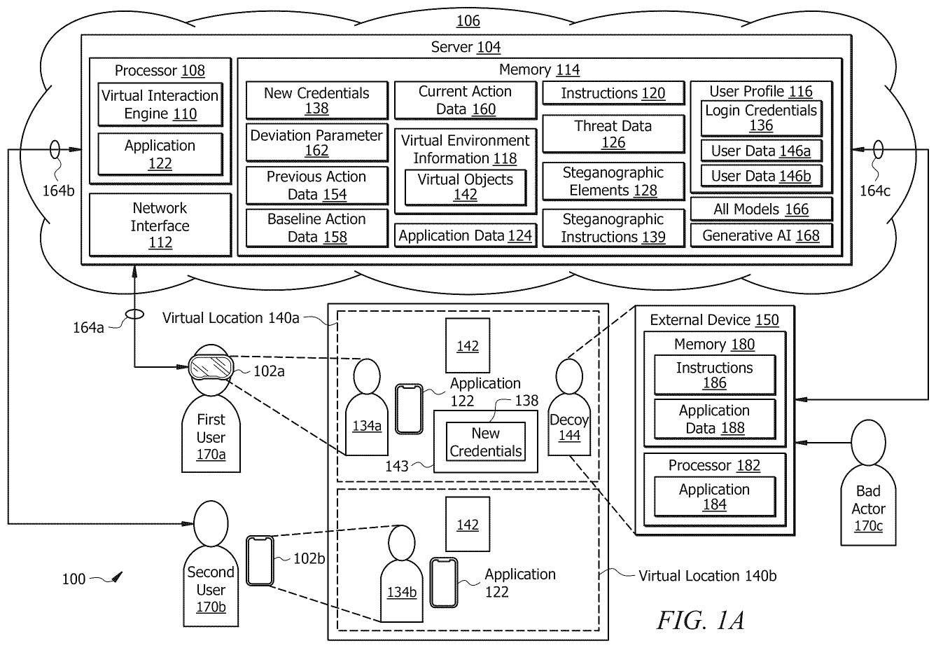

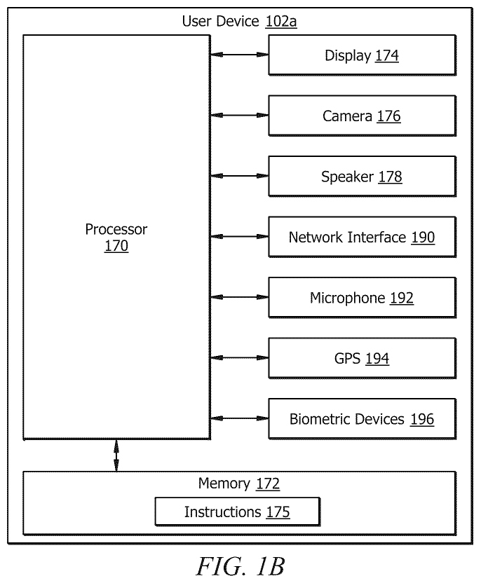

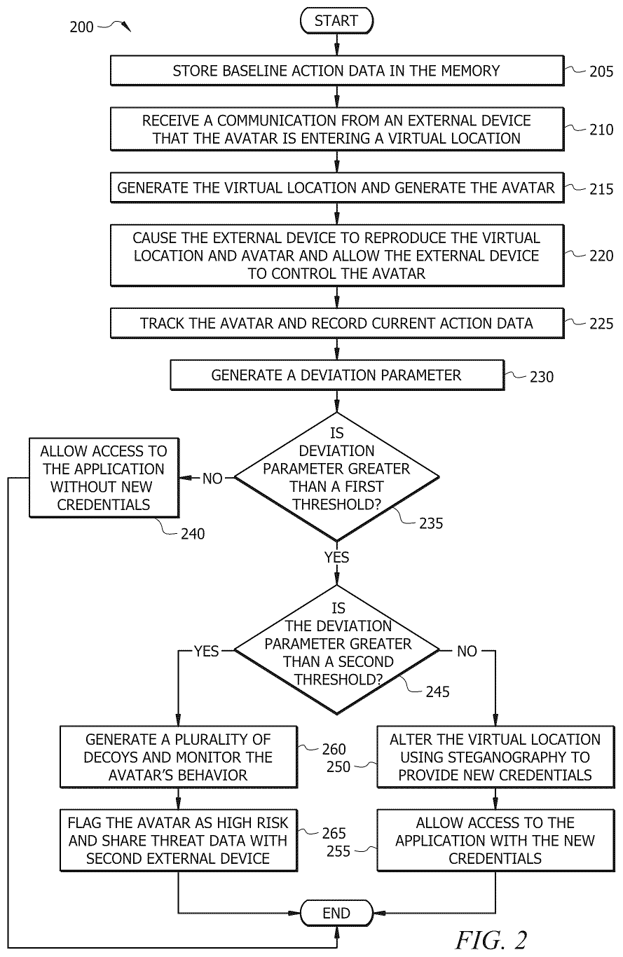

By using the system and method, applications that provide sensitive resources or perform sensitive actions may be securely used in virtual environments without significant user irritation or the need for more computational power by the user's device. Deepfakes and other types of attacks on virtual environments may be quickly identified and neutralized, resulting in a better user experience and a reduction in real-world losses by both users and organizations providing the applications and/or virtual environments. Embodiments of the disclosure and its advantages may be understood by referring to FIG. 1A, FIG. 1B, and FIG. 2.

### System, Overview

FIG. 1A illustrates one embodiment of a system 100 configured to allow users, e.g., 170a, to interact with virtual locations, e.g., 140a, with user avatars, e.g., 134a. The system 100 allows the users, e.g., 170a, to interact with applications 122 through the virtual locations, e.g., 140a, while preventing bad actors 170c using external devices 150 from misusing or hijacking a user avatar, e.g., 134a, to access the applications 122 maliciously. In one or more embodiments, system 100 comprises a server 104, one or more user devices, e.g., 102a, and a network 106. The system 100 may be communicatively coupled to the network 106 and may be operable to transmit data between each user device, e.g., 102a and the server 104 through the network 106. The network 106 may also allow an external device 150 to communicate with the server 104 and/or one or more user devices, e.g., 102a. Server 104 comprises a processor 108 in signal communication with a memory 114. Memory 114 stores instructions 120 that, when executed by the processor 108, cause the processor 108 to perform one or more functions described herein.

In some embodiments, the system 100 may be implemented by a server 104 to allow a first user 170a using a first user device 102a, such as, but not limited to, a virtual reality headset to control and interact with a virtual location 140a using a first user avatar 134a. The server 104 comprises a processor 108, memory 114, and a network interface 112 for communicating with the network 106. Server 104 is configured to generate the virtual location 140a, allowing the first user 170a to interact with virtual objects 142, applications 122, and other users'avatars, e.g., 134b. While preventive actions are taken by the server 104, including some that will be described below, and with regards to FIG. 2, the server may also communicate 164c with an external device 150 controlled by a bad actor 170c or application 184 that has malicious intent. Additional users, e.g., 170b, such as a second user 170b, may interact with a similar or the same virtual location 140b using a second user device 102b controlling a second avatar 134b. While FIG. 1A only shows the first user 170a and the second user 170b, any number of users, e.g., 170a, user devices, e.g., 102a, virtual locations, e.g., 140a, and user avatars, e.g., 134a may be present and interact with server 104 without departing from the disclosure. The server 104 may be a single device or comprise many devices working together, including those in a data center, cloud environment, or other computational device/environment, without departing from the disclosure. The disclosure is not limited to the configuration shown in FIG. 1A.

### System Components

### Network

The network 106 may include any interconnecting system capable of transmitting audio, video, signals, data, messages, or any combination of the preceding. The network 106 may consist of all or a portion of a local area network, a metropolitan area network, a wide area network, an overlay network, a software-defined network, a virtual private network, a packet data network (e.g., the Internet), a mobile telephone network (e.g., cellular networks, such as 4G or 5G), a Plain Old Telephone network, a wireless data network (e.g., Wi-Fi, WiGig, WiMax, etc.), a Long Term Evolution network, a Universal Mobile Telecommunications System network, a peer-to-peer network, a Bluetooth network, a Near Field Communication network, a Zigbee network, and/or any other suitable network. The network 106 may be configured to support any suitable type of communication protocol and have any configuration without departing from the disclosure.

### User Devices

A user device, e.g., 102a, is a hardware device that is generally configured to provide hardware and software resources to a user, e.g., 170a. Examples of a user device, e.g., 102a, include but are not limited to a virtual reality device, an augmented reality device, a laptop, a computer, a smartphone, a tablet, a smart device, an Internet-of-Things (IoT) device, or any other suitable type of device. The user device, e.g., 102a, may comprise a display (see FIG. 1B, display 174) configured to display a graphical user interface (GUI), a touchscreen, a touchpad, keys, buttons, a mouse, or any other suitable type of hardware that allows a user, e.g., 170a to view data and/or to provide inputs into the user device, e.g., 102a.

Each user device, e.g., 102a, is configured to display a two-dimensional (2D) or three-dimensional (3D) representation of a virtual location, e.g., 140a, to a user, e.g., 170a. Each user device, e.g., 102a, is further configured to allow a user, e.g., 170a, to send a request to the server 104 to allow an avatar, e.g., 134a, associated with the user device, e.g., 102a, to enter and navigate through a virtual location, e.g., 140a.

Examples of a virtual location 140a may include but are not limited to, a graphical or virtual representation of a metaverse, a map, a city, a building interior, a landscape, a fictional location, an alternate reality, or any other suitable type of location or environment. A virtual location, e.g., 140a, may be configured to use realistic or non-realistic physics for the motion of virtual objects 142 within the virtual environment, e.g., 140a. Within the virtual environment, e.g., 140a, each user, e.g., 170a, may be associated with a user device, e.g., 102a, and an avatar, e.g., 134a.

An avatar, e.g., 134a, is a graphical representation of the user, e.g., 170a, and/or user device, e.g., 102a, within the virtual location, e.g., 140a. Examples of avatars 134a include but are not limited to, a person, an animal, or an object. In some embodiments, the features and characteristics of the avatar, e.g., 134a, may be customizable. The size, shape, color, attire, accessories, or any other suitable type of appearance features may be specified by a user, e.g., 170a. By using the avatar, e.g., 134a, a user, e.g., 170a, or the user device, e.g., 102a, may move and interact with the virtual location, e.g., 140a, and virtual objects 142 located within it.

FIG. 1B is a block diagram in accordance with one or more embodiments of an exemplary user device 102a from system 100, as shown in FIG. 1A. The exemplary user device 102a may be configured to display the virtual location 140a within a field of view of the first user 170a, capture biometric, sensory, and/or physical information of the user 170a wearing and operating the user device 102a, and facilitate an electronic interaction between the user 170a and the server 104.

In one or more embodiments, the exemplary user device 102a comprises a processor 170, a memory 172, and a display 174. The processor 170 may include one or more processors 170 operably coupled to and in signal communication with memory 172, display 174, camera 176, speakers 178, network interface 190, microphone 192, GPS sensor 194, and biometric devices 196. The one or more processors 170 may be any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The one or more processors 170 may be a programmable logic device, a microcontroller, a microprocessor, or any suitable combination of the preceding. The one or more processors 170 are configured to process data and may be implemented in hardware or software. For example, the processor 170 may be 8-bit, 16-bit, 32-bit, 64-bit, or of any other suitable architecture. The one or more processors 170 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

The one or more processors 170 are configured to implement various instructions 175. Instructions 175 may be stored in memory 172, and one or more processors 170 are configured to execute instructions 175 to implement the functions disclosed herein, such as some or all of those described in FIGS. 1A, 1B, and 2. For example, the one or more processors 170 may be configured to display virtual objects 142 on display 174, capture biometric information of a user 170a using one or more cameras 176, microphones 192, and/or biometric devices 196, and communicate via network interface 190 with server 104 and/or other user devices 102b. In another example, the one or more processors 170 may determine the location of the user device 102a using GPS sensor 194, cameras 176, the network interface 190, or other components, where location data is also used in creating the virtual location 140a or determining a user 170a and/or their avatar's 134a interactions with the virtual location 140a.

The memory 172 is operable to store instructions 175 along with any other information that needs to be locally kept on the user device 102a. The memory 172 comprises one or more disks, tape drives, or solid-state drives and may be used as an over-flow data storage device to store programs when such programs are selected for execution and to store instructions and data that are read during program execution.

The display 174 is configured to present visual information to a user 170a in an augmented reality, virtual reality, and/or metaverse environment. The display 174 may overlay virtual or graphical objects onto tangible objects in a real scene in real time where the user device 102a is part of an augmented reality system. In other embodiments, the display 174 is configured to present visual information about the virtual location 140a in real-time or near real-time to the user 170a.

In one or more embodiments, the display 174 may be a wearable optical display (e.g., glasses or a headset) configured to project or reflect images to the user 170a. In one or more embodiments, the user 170a may be able to see through the display 174. For example, display 174 may comprise display units, lenses, and semi-transparent mirrors embedded in an eyeglass, visor, or helmet structure. The display 174 may include as an image source any of a cathode ray tube (CRT) display, a liquid crystal display (LCD), a liquid crystal on silicon (LCOS) display, a light emitting diode (LED) display, an active-matrix OLED (AMOLED), an organic LED (OLED) display, a projector display, or any other suitable type of display and the disclosure is not limited to those just described. In one or more embodiments, display 174 may be a graphical display 174 on a handheld user device (see FIG. 1A, where a handheld user device 102b is shown as a non-limiting example). For example, the graphical display 174 may be the display 174 of a tablet or smartphone configured to display virtual or graphical objects from the virtual location 140a on a GUI in real-time or near real-time.

Camera 176 is configured to capture images to form a video stream of images, which may be used by the user device 102a and/or the server 104 to authenticate a user 170a and/or create or populate the virtual location 140a. Camera 176 is a hardware device configured to capture images continuously, at predetermined intervals, or on-demand. For example, camera 176 may be configured to receive a command from the user 170a to capture images of the user 170a within a real environment. In another example, camera 176 is configured to continuously capture images of a field of view in front of the user device 102a and/or in front of the camera 176 to form a video stream of images of a real environment. The camera 176 is communicably coupled to processor 170 and configured to transmit the captured images and/or video stream to the server 104.

Similarly, a microphone 192 may be provided to capture audio from the user, e.g., 170a and/or the real-world environment. The microphone 192 is configured to capture audio signals (e.g., voice signals or commands) from a user, e.g., 170a. Microphone 192 may take any form and is communicably coupled to processor 170. The processor 170 may reproduce the audio captured by the microphone 192 and any audio that is part of the virtual location 140a and produced by server 104 using speakers 178. The speaker may take the form of headphones, earbuds, stereo speakers, or any other type of device that reproduces audio, including voice, music, environmental noises, and any other audio that is useful for allowing a user 170a to interact with the virtual location 140a using their avatar 134a.

The network interface 190 is configured to enable wired and/or wireless communications. The network interface 190 is configured to communicate data between the user device 102a and other network devices, systems, or domain(s). For example, the network interface 190 may comprise a WIFI interface, a local area network (LAN) interface, a wide area network (WAN) interface, a modem, a switch, or a router. The network interface 190 may use wireless technologies such as, but not limited to, Bluetooth, RFID, near field, Wi-Fi, ZigBee, or any other suitable wireless communication technology. The network interface 190 may also or instead use a wired network technology such as ethernet, cable, fiberoptics, and any other wired technologies, and the disclosure is not limited to those listed herein. Network interface 190 is configured to facilitate processor 170 being able to communicate with other user devices, e.g., 102b the server 104 and other devices through network 106 or other networks (not shown). The network interface 190 is configured to employ any suitable communication protocol without departing from the disclosure.

GPS sensor 194 is configured to capture and provide geographical location information. For example, it is configured to provide the geographic location of user 170a employing user device 102a. GPS sensor 194 may be configured to provide the geographic location information as a relative geographic location or an absolute geographic location. It may also provide the geographic location information using geographic coordinates (e.g., longitude and latitude) or any other suitable coordinate system. GPS sensor 194 is communicably coupled to processor 170.

Examples of biometric devices 196 may include but are not limited to, retina scanners and fingerprint scanners. Biometric devices 196 are configured to capture information about a user's 170a person's physical characteristics and to output a biometric signal based on captured information. This information may be used by the server 104 to create user data 146a and/or as login credentials 136. The biometric devices 196 are communicably coupled to processor 170.

### Server

Referring back to FIG. 1A, the server 104 is a hardware device generally configured to provide services and software and/or hardware resources to user devices, e.g., 102a. The server 104 is generally a computational device or any other device configured to process data and communicate with user devices, e.g., 102a, via the network 106. The server 104 includes a processor 108 that is operably coupled to a memory 114 and a network interface 112.

The server 104 is generally configured to oversee the production of the virtual locations, e.g., 140a, and the interactions of the user, e.g., 102a, with the virtual locations, e.g., 140a. The server 104 also oversees the operations for providing adaptive credential protection using steganography to reduce the abilities of bad actors 170c and/or their external devices 150 from accessing applications 122, as described further below and in conjunction with the operational flows shown in FIG. 2.

In an embodiment, the processor 108 is configured to allow for interaction between the user devices 102a and the virtual locations 140a. The processor 108 performs a virtual interaction 110 operations to produce and modify the virtual location 140a. The virtual interaction 110 operation is implemented using logic units, FPGAs, ASICs, DSPs, or any other suitable hardware. The virtual interaction 110 operation is configured to operate as described in, for example, FIG. 2. For example, the virtual interaction 110 operations may be configured to produce one or more virtual objects 142 for an avatar, e.g., 134a to interact with along with shadows 143 and other altered virtual objects 142 that contain steganographic elements 128, and decoys 144 for an external device 150 associated with a bad actor 170c to interact with.

In an embodiment, the processor 108 is configured to provide one or more applications 122 or facilitate access to the one or more applications 122 in the virtual location 140a. The one or more applications 122 may take any form and may allow a user, e.g., 170a to access real-world resources. While being shown as being hosted by server 104, the applications 122 may be provided by other servers or computational devices and may be associated with organizations other than server 104. The applications 122 may, for example, be in the form of banking, shopping, entertainment, or other applications. Misuse of the applications 122 by, for example, a bad actor 170c may result in real-world consequences. Consequently, the processor 108 takes various precautions, as described in more detail below and regarding FIG. 2, to prevent unauthorized access to the applications 122.

In particular embodiments, the server 104 may be implemented in the cloud or organized in a centralized or distributed manner. The processor 108 is a hardware device that comprises one or more processors 108 operably coupled to the memory 114. The processor 108 is any electronic circuitry including, but not limited to, state machines, one or more central processing unit (CPU) chips, logic units, cores (e.g., a multi-core processor), field-programmable gate array (FPGAs), application-specific integrated circuits (ASICs), or digital signal processors (DSPs). The processor 108 may be a programmable logic device, a microcontroller, a microprocessor, or any suitable combination of the preceding. The processor 108 is communicatively coupled to and in signal communication with the memory 114 and the network interface 112. The one or more processors are configured to process data and may be implemented in hardware or software. For example, the processor 108 may be 8-bit, 16-bit, 32-bit, 64-bit, or of any other suitable architecture. The processor 108 may include an arithmetic logic unit (ALU) for performing arithmetic and logic operations, processor registers that supply operands to the ALU and store the results of ALU operations, and a control unit that fetches instructions 120 from memory 114 and executes them by directing the coordinated operations of the ALU, registers and other components. The one or more processors are configured to implement various instructions 120. The processor 108 may be a special-purpose computer designed to implement the functions disclosed herein.

The network interface 112 is a hardware device configured to enable wired and/or wireless communications. The network interface 112 is configured to communicate data between user devices, e.g., 102a, and other devices, such as, but not limited to, external devices, e.g., 142. For example, the network interface 112 may comprise an NFC interface, a Bluetooth interface, a Zigbee interface, a Z-wave interface, a radio-frequency identification (RFID) interface, a WIFI interface, a LAN interface, a WAN interface, a PAN interface, a modem, a switch, or a router. The processor 108 is configured to send and receive data using the network interface 112. The network interface 112 may be configured to use any suitable type of communication protocol as would be appreciated by one of ordinary skill in the art.

The memory 114 stores any of the information described above concerning FIG. 1A, as well as that needed for performing the operations shown in FIG. 2, along with any other data, instructions 120, logic, rules, or code operable to implement the function(s) described herein when executed by the processor 108. The memory 114 comprises one or more disks, tape drives, or solid-state drives and may be used as an over-flow data storage device to store programs when such programs are selected for execution and to store instructions and data that are read during program execution. The memory 114 may be volatile or non-volatile. It may comprise a read-only memory (ROM), random-access memory (RAM), ternary content-addressable memory (TCAM), dynamic random-access memory (DRAM), and static random-access memory (SRAM).

The memory 114 is operable to store the instructions 120 as well as data needed for producing the virtual location, e.g., 140a, and allowing a user, e.g., 170a, to interact with the application 122 and virtual objects 142 as will be described below and with regards to FIG. 2. Memory 114 may include a non-transitory computer-readable medium that stores instructions 120 that, when executed by a processor, cause the processor to perform one or more of the actions that will be described below and with regards to FIG. 2.

The memory 114 may include application data 124 for use by the application 122. The memory 114 may also include previous avatar data 154, baseline action data 158, current action data 160, threat data 126, steganographic elements 128, AI models 166, and/or any other data or instructions. The user profile 116 may be stored by the processor 108 in the memory 114. A user profile 116 includes login credentials 136, first user data 146a, and second user data 146b. While only first-user data 146a and second-user data 146b are shown, the user profile 116, in accordance with the disclosure, may include user data for a plurality of users, and the disclosure is not limited to first-user data 146a and second-user data 146b. User data, e.g., 146a, may include one or more user identifiers, username, physical address, email address, phone number, and any other data, such as documents, files, and media items that are needed to create an avatar, e.g., 134a and allow a user, e.g., 170a using a user device, e.g., 102a to interact with a virtual location e.g., 140a through the avatar 134a. The login credentials 136 are associated with a user device, e.g., 102a, and are configured to register the user device, e.g., 102a, to interact with the virtual location, e.g., 140a and/or one or more of the applications 122.

The login credentials 136 may be any form and may include biometrics obtained from biometric devices 196, voice received from a microphone 192, and traditional passwords. The login credentials 136 may be provided by a user, e.g., 170a, or may be supplied automatically by the user device, e.g., 102a. In one or more embodiments, the login credentials 136 may be transmitted by the user device 102a when it communicates 164a with the server 104. The login credential 136 may be encrypted using one or more forms of cryptography or may be provided without encryption.

The memory 114 may also include virtual environment information 118. The virtual environment information 118 may include virtual objects 142 and other information. This virtual environment information 118 may be retained after a user exits a virtual location, e.g., 140a or resets each time the user avatar, e.g., 134a, enters the virtual location, e.g., 140a. The virtual environment information 118 may include a plurality of virtual objects 142 rendered in the virtual location 140a. Although only one virtual object 142 is shown, multiple objects may exist. These virtual objects 142 may include windows, pictures, shadows, light sources, everyday objects like phones, paper, pens, computer devices, and other objects that make the virtual location, e.g., 140a attractive, interactive, aesthetically pleasing, and functional. The virtual objects 142 may also include shadows 143, altered virtual objects 142, and decoys 144, as will be described in more detail below.

The processor 108 interacting with the memory 114 performs virtual interaction 110 to produce a virtual location, e.g., 140a, and allow one or more users, e.g., 170a, to interact with the virtual location, e.g., 140a through an avatar, e.g., 134a controlled by their user device, e.g., 102a. The virtual interaction 110 may use data from the user profile 116 and virtual environment information 118 to create the virtual location, e.g., 140a. The virtual interaction 110 may include but is not limited to, one or more separate and independent software and/or hardware components of a server 104. In some embodiments, the virtual interaction 110 may be implemented by the processor 108 by executing the information stored in the memory 114 as virtual environment information 118 along with instructions 120 to create the virtual locations, e.g., 140a.

However, in one or more embodiments of the disclosure, a bad actor 170c using an external device 150 may send third communications 164c and pretend to be a user device, e.g., 102a. The bad actor 170c using the external device 150 may communicate 164c with the server 104 to indicate that the compromised avatar, e.g., 134a, is entering the virtual location, e.g., 140a. The processor 108 would then interact with the external device 150, including giving the external device 150 and applications 184 operating on it, as well as unauthorized access to the virtual location 140a and the applications 122. In order to prevent this, processor 108, in one or more embodiments, compares baseline action data 158 with current action data 160 and, using an AI model 166 determines if an avatar, e.g., 134a has been compromised. If it has been compromised, the processor 108 then implements steganographic elements 128 to protect the application 122 from the bad actor 170c and may produce decoys 144 that interact with the avatar, e.g., 134a to collect threat data 126, which may comprise of behavior data, action data, attack signatures, internet protocol (IP) addresses for the external devices 150 and other information that may be used to produce countermeasures as well as update the AI model 166.

### External Device

The external device 150 may include any number of devices that perform one or more applications 184. The external device 150 is associated with a bad actor 170c in one or more embodiments. The external device 150 may be similar to the user device, e.g., 102a, or may take a different form. In one or more embodiments, the external device 150 includes an application 184 performed by the processor 182. The application 184 may be malware or artificial intelligence that interacts with the virtual location n140a by hijacking or producing a user avatar, e.g., 134a, using deepfake or other technologies. The application 184 may include application data 188 that is able to provide appropriate login credentials 136 and other information needed by the server to initially produce the user avatar, e.g., 134a. This information may have been obtained offline or through other malware deployed by the external device 150 or bad actor 170c.

Examples of an external device 150 may include but are not limited to, computers, laptops, mobile devices (e.g., smartphones or tablets), servers, clients, or any other suitable type of devices to access or support an application 184. While only one external device 150 is shown, in one or more embodiments, a plurality of external devices, e.g., 150, may be present, each hosting different applications and/or application data 188 needed for the bad actor 170c to interact with the virtual location, e.g., 140a and attempt to access application 122 without authorization.

The external device 150 may include at least one processor 182 that performs one or more processes or operations, including performing application 184. The processor 182 executes instructions 186 stored in the memory 180 to perform the application 184 and/or allow the bad actor 170c to interact with the virtual location, e.g., 140a. The external device 150 may include a memory 180 for storing instructions 186 for performing the application 184. The memory 180 may also include application data 188 for the application 184.

While FIG. 1A shows the external device 150, including only a single processor 182 and a memory 180; the external device 150 may include any suitable number and combination of processors, e.g., 182 and memories 180, as well as any other necessary components. For simplicity, only one processor, e.g., 182, and one memory, e.g., 180, are shown in FIG. 1A.

Returning to the server 104, the processor 108, located in the server 104, may receive user communications, e.g., 164a that include login credentials 136, user data 146a including video data, audio data, movement data, and any other types of data needed for controlling and allowing an avatar, e.g., 134a to interact with a virtual location, e.g., 140a. The communications, e.g., 164a, may initially indicate that a particular user, e.g., 170a, wishes for their avatar, e.g., 134a, to enter the virtual location, e.g., 140a. Once the communication, e.g., 164a from a user, e.g., 170a, or multiple communications 164a and 164b from more than one user, 170a and 17b, the processor performs virtual interaction 110 operations. The processor 108 performing the virtual interaction 110 operations may retrieve a user profile 116 and baseline action data 158 associated with the particular user, e.g., 170a, stored in the memory 114. The user profile 116 and baseline action data 158 may have been created the first time the user's avatar, e.g., 134a, entered the virtual location, e.g., 140a.

Once the communication 164a is initially received, the processor 108 may generate or populate the virtual location 140a with the user's avatar 134a. The virtual location 140a may be associated with one or more applications 122 hosted by the server 104 or may be associated with one or more applications provided by an external server (not shown). The server 104 may present virtual objects 142 that may be interactive and/or in one or more embodiments may be altered to include steganographic elements 128. The user, e.g., 170a through the user device, e.g., 102a, may interact with one or more applications 122, other user's avatars 134b, virtual objects 142 in the virtual location, e.g., 140a on a graphical user interface (GUI) of the user device, e.g., 102a as well as any other elements present in the virtual location, e.g., 140a, and generated using information stored in the memory 114 as virtual environment information 118.

In one or more embodiments, more than one user, 170a and 170b, may interact in the virtual locations 140a and 140b. The server 104 may integrate the first communication 164a sent by the first user device 102a and a second communication 164b sent by the second user device 102b. The data included in the communications 164a and 164b is then combined by the processor 108, and the virtual environment information 118 is altered to present appropriate avatars 134a and 134b as well as interaction objects 142 in both virtual locations 140a and 140b presented or rendered on each appropriate user device, e.g., 102a in real time to allow for interactions between the first user 170a and the second user 170b as well as the applications 122.

When the user avatar, e.g., 134a, enters the virtual location, e.g., 140a, the processor 108 begins to track the current actions that the avatar, e.g., 134a, performs and stores them as current action data 160. The current action data may include such things as micro gestures (small movements that the avatar, e.g., 134a performs, for example, does the avatar, e.g., 134a move fluidly or does it have a more stochastic motion), eye movement patterns (how the avatar and/or user, e.g., 170a looks around the virtual location 140a, for example, does the avatar/user look straight ahead or do they look around in a fluid manner) and cognitive load (does the underlying processor of the user device, e.g., 102a respond swiftly to new information or queries from the processor 108). This and other data are stored as current action data 160 in the memory 114.

The processor 108 compares the current action data 160 with that stored in the baseline action data 158, which includes data on the same things as the current action data 160 for a similar or identical amount of time. For example, the processor 108 may initially track the avatar, e.g., 134a, for the first ten seconds, thirty seconds, minute, or other lengths of time when the avatar 134a first enters the virtual location 140a. The time length may be chosen to give enough time for the processor 108 to determine if the avatar, e.g., 134a, is under the control of an authorized user, e.g., 170a, a bad actor, e.g., 170c, or application 184 hosted by an external device 150 associated with a bad actor, e.g., 170c.

When comparing the current action data 160 with the stored baseline action data 158, the processor 108, in one more embodiment, may use a trained AI model 166 stored in the memory to analyze the current action data 160 and stored baseline action data 158 and generate deviation parameter 162 or a value. The trained AI model compares how much the current actions performed by the avatar, e.g., 134a, and stored in the current action data 160, when the avatar, e.g., 134a, enters the virtual location differ from the plurality of initial actions stored in the baseline action data 158. This deviation parameter 162 may be a probability or other value that is compared with a threshold to determine if preventative actions should be taken before allowing the avatar, e.g., 134a, to access one or more applications 122.

In one or more embodiments, the trained AI model 166 is produced by training an artificial intelligence (AI) algorithm using baseline action data 158, action data 160, and threat data 126 gathered from a plurality of avatars, e.g., 134b stored in the memory 114 as previous avatar data 154. The processor 108 or another device (not shown) external to the server 104, may train the AI algorithm to produce the AI model 166. Alternatively, in one or more embodiments, the AI model 166 may be provided by an outside vendor or other organization that performs the training and updating. The disclosure is not limited to a particular method of producing and/or training the AI model 166, and the following is merely exemplary of one method of making the AI model 166.

In one or more embodiments, when training the AI algorithm to produce AI model 166, the processor 108 receives additional baseline action data, current action data, and threat data for each of a plurality of avatars stored in the previous avatar data 154. The processor 108 then creates a first training set using the received data from the previous avatar data 154 and trains the AI algorithm in a first stage using the first training set to identify from the first plurality of avatars a compromised set of avatars and an uncompromised set of avatars. The processor 108 then identifies a second plurality of avatars from the first plurality of avatars that were incorrectly identified in the first stage and creates a second training set comprising the additional baseline action data, the additional action data, and the additional threat data for the second plurality of avatars. The processor then trains the AI algorithm in a second stage using the second training set to produce the trained AI model 166. Periodically or continuously, the processor 108 updates the trained AI model 166 using threat data 126 and any other collected data anytime a bad actor 170c is detected using a compromised avatar, e.g., 134a. Alternatively or additionally, in one or more embodiments, the AI model 166 is updated with the baseline action data 158, current action data 160, and any other information each time a new user, e.g., 170a, accesses the virtual location, e.g., 140a using an avatar, e.g., 134a controlled by a user device, e.g., 102a or external device 150.

While the deviation parameter 162 is described as being determined by a trained AI model 166, it may be determined by other means, such as a calculation analyzing the difference in the number of micro gestures, actions, or other measurable quantities that have been determined to be indicative of a possible bad actor 170c when it is greater than a particular threshold. For example, if the processor 108 is determining the deviation parameter based on the number of movements, the number of movements in the baseline action data 158 may be subtracted from the number of movements in the current action data 160 for a similar or same period of time. Over time, a user, e.g., 170a, is expected to become more proficient in navigating the virtual location, e.g., 140a; a significant change may indicate that the bad actor 170c now has control of the avatar 134a since a deepfake application 184 or other application would presumably be more efficient in navigating a virtual location 140a then a human. The deviation parameter 162 may be determined by any method, including combinations of the trained AI model and the above-described calculations or another method not described herein, without departing from the disclosure.

If the deviation parameter 162 is determined to be less than the threshold, and therefore presumably the avatar, e.g., 134a, is being controlled by an authorized user, e.g., 170a associated with that avatar, e.g., 134a, the user, e.g., 170a is allowed to access the application 122 through the avatar, e.g., 134a in the normal manner. If, however, the deviation parameter 162 is determined to be greater than the threshold, additional operations are performed by the processor 108 to either prevent the external device 150 associated with the bad actor 170c from accessing the application 122 or to require the user, e.g., 170a to take additional steps and provide new credentials to access the applications 122.

In one or more embodiments when the deviation parameter 162 is greater than the threshold, the processor 108 alters the virtual location, e.g., 140a, using steganographic elements 128 to hide new credentials 138 in one or more normal objects, e.g., 142 to produce altered virtual objects 142. The new credentials 138 are needed for the user, e.g., 170a to access the application 122 through the avatar, e.g., 134a. The one or more normal elements are virtual objects 142 that normally would not include credentials, and the new credentials 138 are concealed in the one or more normal elements, such as the virtual objects 142 in such a way that they are not easily detected. The new credentials 138 may take any form and may be, for example, an alphanumeric sequence of characters that must be provided to access the application 122 or maybe a series of micro gestures or voiced statements that a user, e.g., 170a must speak in order to use the application 122. The new credentials 138 may take any form, and the disclosure is not limited to those just described.

Steganography is the practice of representing information in such a manner that the presence of the information would not be evident to an unsuspecting person's examination. In one or more embodiments, the processor 108, when performing steganography, hides or embeds the new credentials 138 in images such as mirrors or pictures in the virtual location, e.g., 140a. In one or more embodiments, the new credentials 138 are hidden in a shadow 143 of one or more virtual objects 142. The new credential 138 may take any form, including a sequence of characters altered so only a human user would be able to understand them. When a bad actor 170c is using an application 184, such as a deepfake, to control a compromised avatar 134a, it is unlikely that the application 184 would be able to detect the steganographic elements 128. Even where a bad actor 170c directly controls the compromised avatar, e.g., 134a, it is unlikely that a bad actor 170c would pay attention or take the time to interact with the virtual location 140a itself enough to obtain the new credentials 138.

The processor 108 causes the external device 150 or user device 102a to change one or more normal elements, such as the virtual objects 142 to include the steganographic elements 128 and may modify one or more other virtual objects 142 to direct the user, e.g., 170a to observe the steganographic elements 128. In one or more embodiments, the processor 108 when providing steganographic elements 128 also provides steganographic instructions 139 to direct the user, e.g., 170a and/or their avatar, e.g., 134a, to observe the new credentials 138 that may be hidden in an image or may be hidden in audio. In one or more embodiments, only a portion of the steganographic instructions 139 or new credentials 138 may be embedded in a single virtual object 142 or another element of the virtual locations 140a. For example, in a non-limiting example, audio might include the steganographic instructions 139 to “move like the shadow,” and the shadow 143 may make micro gestures that are the actual new credentials 138.

In one or more embodiments, the steganographic instructions 139 may be embedded or hidden in a first virtual object 142, while at least part of the new credentials 138 might be hidden in a second virtual object 142, such as shadow 143. For example, in a non-limiting example, a mirror may say, “Look in the shadow for a new login,” then, in the shadow 143, a sequence of numbers “1, 2, 3, 4” might be displayed to access the application 122. Alternatively, a first shadow may have the first part of a sequence “1, a, 3, b,” while a nearby light beam may include “4, 5, 6”. Other examples include having the shadow 143 or even a decoy 144 make a series of movements not related to the avatar, e.g., 134a; actions such as raising the shadow's 143 hand three times, which is an action the avatar, e.g., 134a must make to access the application 122. The previous are examples, and the disclosure is not limited to those specific examples. The new credential 138 and steganography elements 128 may take any form and may be embedded in any virtual object 142 or elements of the virtual location 140a.

Once the virtual location 140a is altered with the new credentials 138, for example, in a shadow 143 or other virtual objects 142 using steganography, the server 104 continues to track and allow the avatar, e.g., 134a, to interact with the virtual location 140a. At some later time, the server 104 may receive a communication 164a indicating that the avatar, e.g., 170a, wishes to access the application 122. When the deviation parameter is less than the first threshold, the avatar 134a and user device 102a are allowed to access the application 122 using the normal access method, for example, providing a password or simply interacting with it. When the deviation parameter 162 is greater than the first threshold, a request is electronically sent to the user device 102a and/or external device 150 seeking or requesting credentials to access the application 122. In response, the user device 102a or the external device 150 sends credentials to access the application. If the credentials include the new credentials 138 and are correct, the user device 102a is allowed to access the application 122 through the avatar, e.g., 134a. If, however, the new credential 138 does not provide access to the application, 122 will be denied.

In one or more embodiments, after the steganographic elements 128 are introduced and/or after the deviation parameter 162 is calculated, the avatar, e.g., 134a, continues to be tracked. The processor 108 uses this continued tracking to revise the deviation parameter 162 or derive an additional dedication parameter, e.g., 162. The revived deviation parameter 162 or an additional deviation parameter, e.g., 162, are compared to a second threshold. Alternatively, in one or more embodiments, the original deviation parameter 162 is compared to the second threshold without additional tracking of the avatar, e.g., 134a.

In one or more embodiments, the second threshold is a value of the deviation parameter 162 that indicates with more certainty that the avatar, e.g., 134a, is being controlled by an external device 150 associated with a bad actor 170c instead of the authorized user device, e.g., 102a associated with the authorized user, e.g., 170a. The first threshold might be a lower number, such as, in a non-limiting example, 25% probability where there is the possibility that the avatar, e.g., 134a, is being controlled by a bad actor 170c, but more likely that the avatar, e.g., 134a is being controlled by the authorized user, e.g., 170a using their user device, e.g., 102a. At the same time, the second threshold may be a probability, such as, but not limited to, 50%, that indicates that there is little likelihood that the avatar, e.g., 134a, is being controlled by its authorized user, e.g., 170a.

If processor 108 determines the deviation parameter 162 is greater than this second threshold, additional measures are taken by processor 108 to protect the application 122 and/or other aspects of virtual location 140a. For example, processor 108 may disable access to application 122 and/or remove any steganographic elements 128 to ensure that the applicator 184 on the external device 150 that has hijacked or faked the avatar 134a does not learn how to recognize the steganographic elements 128. The processor 108 may also flag the avatar, e.g., 134a and/or the related external device 150, as being high risk, and threat data 126 related to the avatar, e.g., 134a and/or related external device 150, may be shared with a threat prevention device.

The processor 108 introduces one or more decoys 144 in one or more embodiments. The decoys 144 interact with the avatar 134a to mislead the application 184 and/or the bad actor 170c. The decoys 144 in one or more embodiments behave as if they were other avatars, e.g., 134b, and may communicate or interact with the compromised avatar, e.g., 134a, using generative AI 168 to produce dialog so that they may have conversations with the avatar, e.g., 134a. The processor may also control their actions to appear to be controlled by a person. In one or more embodiments, the decoys 144 may be given the ability to appear to interact with the application 122 so that the external device 150 and/or bad actor 170c does not realize that access to the application has been restricted, and the bad actor 170c continues to believe they have not been detected.

In one or more embodiments, the decoys 144 may be designed to cause or encourage the external device 150 and bad actor 170c to continue interacting with the virtual location 140a for a longer period of time than they would if they knew they had been detected. By encouraging or causing the external devices 150 and/or bad actor 170c to continue interacting, the server is able to collect current action data 160 as well as other data such as network data, identification data, and any other data that may be useful as threat data 126. This threat data 126 is used to update the AI models 166 and/or take security measures against the external device 150 and/or bad actors. For example, in a non-limiting example, the threat data 126 may be sent to network security devices to block the external device 150 from accessing server 104 and/or other servers (not shown). Further, notifications may be sent based on the threat data 126 to other organizations so that they may also take preventative measures. Notification may also be sent to law enforcement to take legal action against the bad actor 170c.

### Process for Using Adaptive Credential Protection Using Steganography

FIG. 2 is a flowchart of an embodiment of method 200 performed by a processor 108 for using adaptive credential protection in a virtual location, e.g., 140a. The processor 108 may execute instructions 120 stored in memory 114, which employs method 200 for using adaptive credential protection for a user avatar, e.g., 132, that enters a virtual location, e.g., 104a.

Method 200 begins at operation 205 when processor 108 stores baseline action data 158 in the memory 114. The baseline action data 158 shows how a particular avatar 134a behaves and moves the first time it enters the virtual location 140a. Either the assumption is made that the avatar 134a is being controlled by user device 102a associated with an authorized user 170a of that user device 102a and avatar 134a during its first encounter with the virtual location 140a or other actions are taken to authenticate the user 170a and/or user device 102a, such as collecting biometric data using a biometric device 196, passwords, and any other method of verify a user 170a, user device 102a, and avatar 134a. When the avatar 134a enters the virtual location 140a for the first time, data about its movements, such as but not limited to micro gestures and eye movements, are collected and stored in the memory 114 as baseline action data 158. This baseline action data 158 may include movement data for the entire time the avatar 134a interacts with the virtual location 140a or for a specific initial period, for example, the first thirty seconds, first minute, and first ten minutes, depending on the complexity of the virtual location 140a and the memory's 114 capacity.

Once the baseline action data 158 is stored in the memory 114 in operation 205, the processor in operation 210 receives at a later time a communication 164c from an external device 150 that the avatar 134a is entering the virtual location 140a. While FIG. 2 describes the communication 164c coming from an external device 150, the external device may be any device, including the user device 102a, that is able to control the avatar 134a and interact with the virtual location 140a. The external device 150 is not limited to an external device 150 that is controlled by a bad actor 170c and may be any external device 150 without departing from the disclosure.

Once the processor 108 receives the communication 164c from the external device 150 in optional operation 210, the processor 108 generates the virtual location 140a and avatar 134a in operation 215 when the virtual location 140a has not been previously generated. For example, in a non-limiting example, if the virtual location 140a is specific to each user, e.g., 170a, the virtual location 140a may only be generated when the user 170a is in the virtual location 140a. Once the processor 108 has generated the virtual location 140a in operation 215 or when the virtual location 140a has already been generated, the processor 108 in operation 220 causes the external device 150 to reproduce the virtual location 140a and avatar 134a and the external device 150 is allowed to control the avatar 134a. The external device 150 begins to move the avatar 134a around and/or interact with virtual objects 142 and/or other avatars, e.g., 134b.

The actions and interactions that the avatar 134a makes are tracked and recorded as current action data 160 in operation 225. The processor 108 may track the avatar 134a and record the current action data 160 for a predetermined initial period of time that is the same or similar to that of the baseline action data 158. Alternatively, the processor 108 may continuously track the avatar 134a as long as it is in the virtual location 140a. The current action data 160 is then compared with the baseline action data 158 by the processor 108 in operation 230 to generate a deviation parameter 162.

The processor 108 in operation 230 generates a deviation parameter 162. The processor 108 generates the deviation parameter 162 by comparing the current action data 160 with the stored baseline action data 158. The processor 108, in one more embodiment, may use an algorithm associated with a trained AI model 166 stored in the memory 114 to analyze the current action data 160 and stored baseline action data 158 and generate the deviation parameter 162 or a value. The trained AI model compares how much the current actions performed by the avatar 134a and stored in the current action data 160 differs from the plurality of initial actions stored in the baseline action data 158.

While the deviation parameter 162 is described as being determined by a trained AI model 166, it may also or instead, in accordance with one or more embodiments, be determined by performing one or more calculations that analyze the difference in the number of micro gestures, actions, or other measurable quantities that have been determined to be indicative of a possible bad actor. For example, if the processor 108 is determining the deviation parameter 162 based on the number of movements; the number of movements in the baseline action data 158 may be subtracted from the number of movements in the current action data 160 for a similar or same period of time. Over time, a user, e.g., 170a, is expected to become more proficient in navigating the virtual location, e.g., 140a; however, a significant change may indicate that the bad actor 170c now has control of the avatar 134a since a deepfake application 184 or other application would presumably be much more efficient in navigating a virtual location 140a then a human. The deviation parameter 162 may be determined by any method, including combinations of the trained AI model 166 and the above-described calculations or another method not described herein, without departing from the disclosure.

Once the deviation parameter 162 is generated by the processor 108 in operation 230, the processor 108 determines in operation 235 if the deviation parameter 162 is greater than a first threshold. The first threshold may be a predetermined value or percentage that is selected based on previous interactions with the avatar 134a or based on other determinations that have been made with other avatars, e.g., 134b, threat data 126, other users, e.g., 170b or based on organizational preferences. The first threshold in one or more embodiments may be a probability that indicates that there is a chance that avatar 134a is being controlled by a bad actor 170c, but also a chance that the avatar 134a is being controlled by the authorized user 170a.

The processor 108 in operation 235 determines if the deviation parameter 162 is greater than the first threshold. If it is not, the processor 108 allows access to the application 122 without new credentials 138 in operation 240. If the processor 108 in operation 235, however, determines that the deviation parameter 162 is greater than the first threshold, the processor 108 then determines in operation 245 if the deviation parameter 162 is greater than a second threshold. The second threshold is chosen similarly to the first threshold as a value or probability that indicates that it is more likely that a bad actor 170c is controlling the avatar 134a, and access to the application 122 should be prohibited.

When the processor 108 in operation 245 determines that the deviation parameter 162 is less than the second threshold, the processor 108 alters the virtual location using steganography to provide new credentials in operation 250. The new credentials 138 are needed for the user, e.g., 170a to access the application 122 through the avatar, e.g., 134a for accessing the application 122, wherein the one or more normal elements are virtual objects 142 that normally would not include credentials, and the new credentials 138 are concealed in the one or more normal elements such as a shadow 143 or other virtual objects 142 in such a way that they are not easily detected. The new credentials 138 may take any form and may be, for example, an alphanumeric sequence of characters that must be provided to access the application 122 or maybe a series of micro gestures or voiced statements that a user, e.g., 170a must speak in order to use the application 122. The new credentials 138 may take any form, and the disclosure is not limited to those just described.

In one or more embodiments, the processor 108, when performing steganography, hides or embeds the new credentials 138 in images such as mirrors or pictures in the virtual location, e.g., 140a. In one or more embodiments, the new credentials 138 are hidden in a shadow 143 of one or more virtual objects 142. The new credential 138 may take any form, including a sequence of characters altered so only a human user would be able to understand them. When a bad actor 170c is using an application 184, such as a deepfake, to control a compromised avatar 134a, it is unlikely that the application 184 would be able to detect the steganographic elements 128. Even where a bad actor 170c directly controls the compromised avatar, e.g., 134a, it is unlikely that a bad actor 170c would pay attention or take the time to interact with the virtual location 140a itself enough to obtain the new credentials 138 as the bad actor 170c is probably more focused on the application 122 itself and any real-world resources that may be obtained through it, rather than the entertainment or aesthetic aspects of the virtual location 140a.

The processor 108 causes the external device 150 or user device 102a to change one or more normal elements, such as the virtual objects 142 to include the steganographic elements 128 and may modify one or more other virtual objects 142 to direct the user, e.g., 170a to observe the steganographic elements 128. In one or more embodiments, the processor 108 when providing steganographic elements 128 also provides steganographic instructions 139 to direct the user, e.g., 170a and/or their avatar, e.g., 134a, to observe the new credentials 138 that may be hidden in an image or may be hidden in audio. In one or more embodiments, only a portion of the steganographic instructions 139 or new credentials 138 may be embedded in a single virtual object 142 or another element of the virtual locations 140a. For example, in a non-limiting example, audio might include the steganographic instructions 139 to “move like the shadow,” and the shadow 143 may make micro gestures that are the actual new credentials 138.

In one or more embodiments, the steganographic instructions 139 may be embedded or hidden in a first virtual object 142, while at least part of the new credentials 138 might be hidden in a second virtual object 142, such as shadow 143. For example, in a non-limiting example, a mirror may say, “Look in the shadow for a new login,” then, in the shadow 143, a sequence of numbers “1, 2, 3, 4” might be displayed to access the application 122. Alternatively, a first shadow 143may have the first part of a sequence “1, a, 3, b,” while a nearby light beam may include “4, 5, 6”. Other examples include having the shadow 143 or even a decoy 144 make a series of movements not related to the avatar, e.g., 134a; actions such as raising the shadow's 143 hand three times, which is an action the avatar, e.g., 134a must make to access the application 122. The previous are examples, and the disclosure is not limited to those specific examples. The new credential 138 and steganography elements 128 may take any form and may be embedded in any virtual object 142 or elements of the virtual location 140a.

Returning to the method 200 shown in FIG. 2, once the virtual location 140a is altered with the new credentials 138 in operation 250, the processor 108 then allows access to the application 122 with the new credentials 138 in operation 255. If, however, the processor in operation 245 determines that the deviation parameter 162 is greater than the second threshold, the processor 108 generates a plurality of decoys 144 and monitors the avatar's 134a behavior in operation 260. The processor 108 in operation 260 introduces one or more decoys 144 in one or more embodiments. The decoys 144 interact with the avatar 134a to mislead the application 184 and/or the bad actor 170c. The decoys 144 in one or more embodiments behave as if they were other avatars, e.g., 134b, and may communicate or interact with the compromised avatar, e.g., 134a, using generative AI 168 to produce dialog so that they may have conversations with the avatar, e.g., 134a that are realistic or at least difficult for the bad actor 170c to detect. The processor may also control their actions to appear to be controlled by a person. In one or more embodiments, the decoys 144 may be given the ability to appear to interact with the application 122 so that the external device 150 and/or bad actor 170c does not realize that access to the application 122 has been restricted, and the bad actor 170c continues to believe they have not been detected.

In one or more embodiments, the decoys 144 may be designed to cause or encourage the external device 150 and bad actor 170c to continue interacting with the virtual location 140a for a longer period of time than they would if they knew they had been detected. By encouraging or causing the external devices 150 and/or bad actor 170c to continue interacting, the processor 108 is able to collect current action data 160 as well as other data such as network data, identification data, and any other data that may be useful as threat data 126.

At the same time or while monitoring, the processor 108 in operation 265 flags the avatar 134a as high risk and shares collected threat data 126 with at least a second external device such as a threat prevention device. For example, the processor 108 may share IP address information for the external device 150 with a firewall to block the external device 150 from accessing the virtual location 140a and/or the server 104 in the future. The threat data 126 may also be shared with external threat prevention devices that monitor traffic and prevent attacks on applications 122 from other vectors besides the virtual location 140a; for example, the threat data 126 may include particulars of the bad actor 170c and/or the deepfake performed by the application 184 that could also be detected in a chat box in a web-based application. The processor 108 may also notify law enforcement and/or other entities that an attack has occurred or is being attempted so that appropriate actions may be taken against the bad actor 170c to minimize or stop future attacks by the bad actor 170c. The processor 108 in operation 265 may share the threat data or a portion of it with any external device that is useful for protecting the server 104, the application 122, or even a competitor's applications, and the disclosure is not limited to previous examples. In one or more embodiments, the threat data 126 may also be used to update the AI models 166. While performing operations 260 and 265, the processor 108 may also disable access to application 122 and/or remove any steganographic elements 128 to ensure that the application 184 on the external device 150 that has hijacked or faked the avatar 134a does not learn how to recognize the steganographic elements 128.

Once one of the operations 240, 255, or 265 is completed, method 200 of FIG. 2 ends. The present examples are to be considered illustrative and not restrictive, and the intention is not to be limited to the details given herein. For example, the various elements or components may be combined or integrated into another system, or certain features may be omitted or not implemented.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system, or certain features may be omitted or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system comprising:
a memory operable to store:
baseline action data for an avatar performing initial actions in a virtual location, wherein the baseline action data comprises information about each of a plurality of initial actions that the avatar performs when the avatar enters the virtual location for a first time; and
a processor operably coupled to the memory, the processor configured to:
electronically receive a communication from an external device associated with the avatar, wherein the communication indicates that the avatar is entering the virtual location, wherein the virtual location is configured to allow the external device through the avatar to access an application, wherein the application provides a resource associated with a second external device;
cause the external device to reproduce the virtual location and avatar on at least a graphical user interface (GUI) of the external device and allow the external device to control the avatar in the virtual location;
track the avatar and record action data for actions performed by the avatar when the avatar enters the virtual location;
generate a deviation parameter that indicates a probability that the external device is being controlled by a different user than an authorized user of the avatar, wherein the deviation parameter is generated by using a trained artificial intelligence (AI) model that compares how much the actions performed by the avatar when the avatar enters the virtual location differ from the plurality of initial actions stored in the baseline action data;
alter the virtual location using steganography to hide new credentials in one or more normal elements when the deviation parameter is greater than a first threshold probability that indicates that the avatar may be compromised, wherein altering the virtual location using steganography comprises having the processor:
change the one or more normal elements of the virtual location to include the new credentials for accessing the application, wherein the one or more normal elements are elements that normally would not include credentials, and the new credentials are concealed in the one or more normal elements in such a way that they are not easily detected, and
cause the external device to reproduce the changed one or more normal elements of the virtual location;
electronically receive from the external device a second communication indicating that the avatar is requesting to access the application;
electronically send a request to the external device seeking credentials to access the application;
electronically receive from the external device the credentials to access the application; and
allow the external device through the avatar to access the application when the new credentials are included in the credentials received from the external device.

2. The system of claim 1, wherein the processor is further configured to:
flag the avatar and the external device when the deviation parameter is greater than a second threshold probability, indicating that the avatar is being controlled by a bad actor;
remove the new credentials from the one or more normal elements;
disable access for the avatar to the application;
continue tracking the avatar and record any additional action data as threat data;
communicate identification information of the avatar and the flagged external device with additional external devices that provide additional virtual locations or applications; and
share the threat data with a threat prevention device to reduce a bad actor's ability to access the additional virtual locations or applications.

3. The system of claim 2, wherein the processor is further configured to:
generate a plurality of decoys when the deviation parameter is greater than the second threshold probability;
cause the external device to reproduce the plurality of decoys on at least the GUI; and
cause the plurality of decoys to interact with one or more objects in the virtual location and to communicate with the avatar, wherein the plurality of decoys comprises additional avatars that are configured to attempt to mislead a bad actor associated with the avatar into believing they have not been detected and wherein the one or more objects include the application.

4. The system of claim 3, wherein the plurality of decoys communicates with the avatar using generative AI to generate one or more conversations with the avatar.

5. The system of claim 2, wherein:
an AI algorithm of the AI model is trained by:
receiving additional baseline action data, additional action data, and additional threat data for a first plurality of avatars;
creating a first training set comprising the additional baseline action data, the additional action data, and the additional threat data for the first plurality of avatars;
training the AI algorithm in a first stage using the first training set to identify from the first plurality of avatars a compromised set of avatars and an uncompromised set of avatars;
identifying a second plurality of avatars from the first plurality of avatars that were incorrectly identified in the first stage;
creating a second training set comprising the additional baseline action data, the additional action data, and the additional threat data for the second plurality of avatars; and
training the AI algorithm in a second stage using the second training set to produce the trained AI model;
wherein the processor is further configured to update the trained AI model using the threat data.

6. The system of claim 1, wherein the baseline action data further comprises information on type, sequence, and characteristics of the plurality of initial actions performed when the avatar initially enters the virtual location, and when generating the deviation parameter, the processor using the trained AI model determines how much the type, sequence, and characteristics of the actions performed by the avatar when the avatar enters the virtual location differ from the type, sequence, and characteristics of the plurality of initial actions to determine the deviation parameter.

7. The system of claim 1, wherein the actions comprise eye movements and micro gestures.

8. The system of claim 1, wherein the processor is further configured to:
allow the external device to access the application without providing the new credentials when the deviation parameter is less than the first threshold probability.

9. The system of claim 1, wherein the changed one or more normal elements of the virtual location comprise an altered image that includes at least a portion of the new credentials embedded in it, wherein the new credentials comprise a sequence of characters that contain instructions for additional actions or information that need to be provided to access the application, and wherein the altered image is a shadow, reflection, or other image that includes the sequence of characters altered so only a human user would be able to understand them.

10. The system of claim 1, wherein the changed one or more normal elements of the virtual location comprise altered audio that includes at least a portion of the new credentials embedded in it.

11. A method, comprising:
electronically receiving a communication from an external device associated with an avatar, wherein the communication indicates that the avatar is entering a virtual location, wherein the virtual location is configured to allow the external device through the avatar to access an application, wherein the application provides a resource associated with a second external device;
causing the external device to reproduce the virtual location and avatar on at least a graphical user interface (GUI) of the external device and allow the external device to control the avatar in the virtual location;
tracking the avatar and recording action data for actions performed by the avatar when the avatar enters the virtual location;
generating a deviation parameter that indicates a probability that the external device is being controlled by a different user than an authorized user of the avatar, wherein the deviation parameter is generated by using a trained artificial intelligence (AI) model that compares how much the actions performed by the avatar when the avatar enters the virtual location differ from a plurality of initial actions stored in baseline action data, wherein the baseline action data comprises information about each of a plurality of initial actions that the avatar performs when the avatar enters the virtual location for a first time;
altering the virtual location using steganography to hide new credentials in one or more normal elements when the deviation parameter is greater than a first threshold probability that indicates that the avatar may be compromised, wherein altering the virtual location using steganography comprises:
changing the one or more normal elements of the virtual location to include the new credentials for accessing the application, wherein the one or more normal elements are elements that normally would not include credentials, and the new credentials are concealed in the one or more normal elements in such a way that they are not easily detected, and
causing the external device to reproduce the changed one or more normal elements of the virtual location;
electronically receiving from the external device, a second communication indicating that the avatar is requesting to access the application;
electronically sending a request to the external device seeking credentials to access the application;
electronically receiving from the external device, the credentials to access the application; and
allowing the external device through the avatar to access the application when the new credentials are included in the credentials received from the external device.

12. The method of claim 11, further comprising:
flagging the avatar and the external device when the deviation parameter is greater than a second threshold probability, indicating that the avatar is being controlled by a bad actor;
removing the new credentials from the one or more normal elements;
disabling access for the avatar to the application;
continuing tracking the avatar and recording any additional action data as threat data;
communicating identification information of the avatar and the flagged external device with additional external devices that provide additional virtual locations or applications; and
sharing the threat data with a threat prevention device to reduce a bad actor's ability to access the additional virtual locations or applications.

13. The method of claim 12, further comprising:
generating a plurality of decoys when the deviation parameter is greater than the second threshold probability;
causing the external device to reproduce the plurality of decoys on at least the GUI; and
causing the plurality of decoys to interact with one or more objects in the virtual location and to communicate with the avatar, wherein the plurality of decoys comprises additional avatars that are configured to attempt to mislead a bad actor associated with the avatar into believing they have not been detected and wherein the one or more objects include the application.

14. The method of claim 13, wherein the plurality of decoys communicates with the avatar using generative AI to generate one or more conversations with the avatar.

15. The method of claim 12, further comprises:
initially training an artificial intelligence algorithm of the AI model by:
receiving additional baseline action data, additional action data, and additional threat data for a first plurality of avatars;
creating a first training set comprising the additional baseline action data, the additional action data, and the additional threat data for the first plurality of avatars;
training the AI algorithm in a first stage using the first training set to identify from the first plurality of avatars a compromised set of avatars and an uncompromised set of avatars;
identifying a second plurality of avatars from the first plurality of avatars that were incorrectly identified in the first stage;
creating a second training set comprising the additional baseline action data, the additional action data, and the additional threat data for the second plurality of avatars; and
training the AI algorithm in a second stage using the second training set to produce the trained AI model; and
updating the trained AI model using the threat data.

16. A non-transitory computer-readable medium storing instructions that, when executed by a processor, cause the processor to:
electronically receive a communication from an external device associated with an avatar, wherein the communication indicates that the avatar is entering a virtual location, wherein the virtual location is configured to allow the external device through the avatar to access an application, wherein the application provides a resource associated with a second external device;
cause the external device to reproduce the virtual location and avatar on at least a graphical user interface (GUI) of the external device and allow the external device to control the avatar in the virtual location;
track the avatar and record action data for actions performed by the avatar when the avatar enters the virtual location;
generate a deviation parameter that indicates a probability that the external device is being controlled by a different user than an authorized user of the avatar, wherein the deviation parameter is generated by using a trained artificial intelligence (AI) model that compares how much the actions performed by the avatar when the avatar enters the virtual location differ from a plurality of initial actions stored in baseline action data, wherein the baseline action data comprises information about each of a plurality of initial actions that the avatar performs when the avatar enters the virtual location for a first time;
alter the virtual location using steganography to hide new credentials in one or more normal elements when the deviation parameter is greater than a first threshold probability that indicates that the avatar may be compromised, wherein altering the virtual location using steganography comprises:
changing the one or more normal elements of the virtual location to include the new credentials for accessing the application, wherein the one or more normal elements are elements that normally would not include credentials, and the new credentials are concealed in the one or more normal elements in such a way that they are not easily detected, and
causing the external device to reproduce the changed one or more normal elements of the virtual location;
electronically receive from the external device a second communication indicating that the avatar is requesting to access the application;
electronically send a request to the external device seeking credentials to access the application;
electronically receive from the external device the credentials to access the application; and
allow the external device through the avatar to access the application when the new credentials are included in the credentials received from the external device.

17. The non-transitory computer-readable medium of claim 16, wherein the instructions further cause the processor to:
flag the avatar and the external device when the deviation parameter is greater than a second threshold probability, indicating that the avatar is being controlled by a bad actor;
remove the new credentials from the one or more normal elements;
disable access for the avatar to the application;
continue tracking the avatar and record any additional action data as threat data;
communicate identification information of the avatar and the flagged external device with additional external devices that provide additional virtual locations or applications; and
share the threat data with a threat prevention device to reduce a bad actor's ability to access the additional virtual locations or applications.

18. The non-transitory computer-readable medium of claim 17, wherein the instructions further cause the processor to:
generate a plurality of decoys when the deviation parameter is greater than the second threshold probability;
cause the external device to reproduce the plurality of decoys on at least the GUI; and
cause the plurality of decoys to interact with one or more objects in the virtual location and to communicate with the avatar, wherein the plurality of decoys comprises additional avatars that are configured to attempt to mislead a bad actor associated with the avatar into believing they have not been detected and wherein the one or more objects include the application.

19. The non-transitory computer-readable medium of claim 18, wherein the plurality of decoys communicates with the avatar using generative AI to generate one or more conversations with the avatar.

20. The non-transitory computer-readable medium of claim 16, wherein the instructions further cause the processor to:
initially train an artificial intelligence algorithm of the AI model by:
receive additional baseline action data, additional action data, and additional threat data for a first plurality of avatars;
create a first training set comprising the additional baseline action data, the additional action data, and the additional threat data for the first plurality of avatars;
train the AI algorithm in a first stage using the first training set to identify from the first plurality of avatars a compromised set of avatars and an uncompromised set of avatars;
identify a second plurality of avatars from the first plurality of avatars that were incorrectly identified in the first stage;
create a second training set comprising the additional baseline action data, the additional action data, and the additional threat data for the second plurality of avatars; and
train the AI algorithm in a second stage using the second training set to produce the trained AI model; and
update the trained AI model using the threat data.
